(19) United States
(12) Patent Application Publication
(10) Pub. No.: US 2016/0109069 A1
(43) Pub. Date: Apr. 21, 2016

(54) TUBULAR LED LAMP

(71) Applicant: Luis Avina Silva, (US)

(72) Inventor: Luis Avina Silva, Tlajomulco de Zuniga, Jal (MX)

(21) Appl. No.: 14/441,173

(22) PCT Filed: Nov. 14, 2012
(86) PCT No.: PCT/MX2012/000116

§ 371 Date: Oct. 1, 2015

(30) Foreign Application Priority Data
Nov. 6, 2012 (MX) MX/A/2012/012917

(51) Int. Cl. F21K 99/00; F21V 29/15; F21V 15/015; F21V 29/70; F21V 23/06; F21V 17/06; F21V 21/005; F21V 29/89

(52) U.S. Cl. CPC F21K 9/175; F21V 21/005; F21V 29/15; F21V 29/89; F21V 29/70; F21V 23/06; F21V 17/06; F21V 15/015; F21Y 2103/003

(57) ABSTRACT

The present invention relates to internal use in offices, businesses, production areas, etc. This product could replace fluorescent, incandescent, halogen, and any other type of lamp or luminaire for internal use. The lamp was designed to maximize the air flow and to obtain an adequate heat transfer rate between the lamp and the environment. On the other hand, need to be brought to your attention that some of the component comprising the tubular lamp will be manufactured using Aluminum and/or other appropriate material to increase the heat exchange rate between the lamp and the environment and thus avoid overheating the LEDs to prevent a premature failure.

Each PCBA board can be individually exchanged, replaced or removed individually, which will allow the tubular lamp to continue operating even when one or more PCBA boards have stopped working. The PCBA boards could be exchanged by disconnecting the lamp from the electrical source, and removing the side caps, side cover, and to disconnect the damaged PCBA board to replace it by another one. Once the PCBA board has been replaced by another one, the later would have to be connected to the multiple connector and subsequently the side cover, side caps, would need to be replaced to restart the tubular lamp.

The metal base and the PCBA boards were designed to control the temperature inside the tubular lamp, and in the way, to minimize the risk of damage to the PCBA boards and/or power source. The operating temperature of the LEDs is very important since the useful life, brightness and color of the LEDs all depend on it. Hence, is imperative to assure that the operating temperature is in the range of (−30° to 85° ) degrees Celsius. The lamp shade of the tubular lamp will be smooth in the inside, but on the external surface it could be smooth, stripped, rough or opaque. These characteristics will help to obtain the require amount of lighting. On the other hand, the side covers and the side caps will be made of a mixture of polymers and organic fibers so that these components can be degraded in a lesser amount of time once the useful life has been reached. The PCBA boards, unifying plates, as well as the metal base of the tubular lamp will be made of 100% recycled materials to reduce the environmental pollution and at the same time reduce the manufacturing costs. Finally, it is worth to be mentioned that the tubular lamp can be disassemble 100% and most of its components can be replaced, exchanged, and/or changed, except the power source, unless it has the same size and electrical characteristics (current, voltage, frequency, etc.), in the same manner the LEDS in individual form (due to the fact that these cannot be de-soldered).

The present invention relates to a tubular lamp (Light Emitting Diodes), consisting of printed circuit board assembly “PCBA”, with one or more LEDs and a connector for an easy disassembly. It also has a power source, side covers with one or more metal contacts, and a multiple connector which is placed inside a semicircular base and lamp shade. The electronic PCBA boards include one or more LEDs, which can be interchanged, removed, or replaced to provide different densities and luminous patterns. The semicircular lampshade will be made with a transparent polymer which facilitates the transfer of the light to the outside. The lampshade can be interchanged, removed or replaced for another with optimal characteristics to reach the desired amount of light. The lampshades can be smooth, grooved, or otherwise have an irregular surface to provide different densities and luminous patterns. The lampshade together with the number of LEDs helps to provide the necessary light output to illuminate the desired area.

Within the base and the lampshade there are one or more PCBA boards, which will contain at least one LED, and at least one SMT type connector. The connector will be used to connect each PCBA board to a multiple connector to obtain the amount of voltage and current needed to supply the PCBA boards with LEDs. The power source will be in charge of supplying the amount of voltage and current necessary for the PCBA boards to work properly. At each end of the lamp, there are circular side covers with at least one snap (hook) in its periphery and at least one hole in its flat surface, which seal the lamps and prevent any external matter to enter them. The side covers act as electricity conductor, which will be transmitted to the power source, and this in turn will provide the required amount of current and voltage to the PCBA boards with LEDs.

Altogether, the mechanical, electric and electronic components will help to provide a better option which will offer a greater density and luminous flux.

To obtain a better efficiency and effectiveness of the invention, we must consider the following: heat transfer, insulation of the light emitting components, electrical safety, and optical effects to obtain the best luminous flux coming from the LEDs.

### BACKGROUND

Currently fluorescent lamps, mixing light metal lamps, halide lamps, compact fluorescent lamps, as well as incandescent lamps are used for indoor and outdoor lighting for residential, commercial and industrial purposes in Mexico and in other countries around the world. Although the fluorescent lamps, mixing light metal lamps, halide lamps, compact fluorescent lamps, as well as incandescent lamps have shown technological advances, these have been surpassed by the LED technology in some cases. This technology requires that one or more LEDs are used to provide the amount of light required to illuminate a specific area. Depending on the client's needs, it is possible to use lenses, diffusers or other mechanism to focus the luminous flux to a specific area and thus make the illumination process more efficient and reduce energy losses.

The lighting technology based on LEDs has demonstrated a significant consumption reduction of electrical energy, has increased the quality and quantity of light and has decreased the heat generation and pollution. At present, there a number of companies that develop and manufacture lamps, luminaries, spotlights, and other LED products to satisfy the needs and likes of the users all over the world. Some of these products include Aluminum or other heat conductive alloys carcasses, side covers, transparent lampshades, power source, as well as LEDs assembled in PCBA boards. Some products use conventional LEDs and lampshades with lenses or bifocal systems to direct the light flux in the desired direction and thus, obtain the desired luminous flux. This type of products do not use a power source to supply the current and voltage to the LEDs. The amount of current is controlled by resistors which prevent the amount of current in the electrical circuit to be infinite. Other products include a power source, which provides the amount of current and voltage needed to completely turn on the LEDS. The lampshade resembles an extruded cylinder of certain length and diameter. These products have two side covers which are joined to the lampshade by means of flexible snaps (hooks). The lampshade has two hooks at each end, which serve for attachment to the side covers. The side covers have two grooves to which the hooks engage produce an assembly between the lampshade and both side covers. However, in this product there is only one PCBA board with LEDs, it lacks a metal base and have a single power source. The current in the electronic circuit in the PCBA board is controlled by electrical resistors. Another product only has a PCBA board with LEDs and a pair of side covers with metal connectors to feed the power source. This product has a metal base and a light-emitting lampshade, but does not solve the problem of minimizing the total investment of the lamp if any of its electronic or electrical components fail. In other words, this lamp lacks the ability to change, replace or eliminate any component if they are damaged or fail working. There are other products which use a PCBA board with LEDs and a power source. The PCBA board as well as power source are inside the lamp. This type of lamps have side covers, which can be removed to replace the PCBA board, but there is only one PCBA board in the lamp. Other types of lamps have a tubular appearance. In this type of lamps, LEDs are supplied with current by the use of a power source, which in turn can control the current flux by means of a photo sensor, which in combination with a presence sensor, timer or controller that can reduce or eliminate the current and voltage supplied to the LEDs. The current reduction will cause the LEDs to attenuate their brightness and intensity during specific periods of time. Even though this option is available in some type of lamps, it is not a standard feature in all the lamps. Dimming systems, timers, presence sensors, controllers and photo sensors are standard components in many of the power sources available in the market. Other LEDs lamps contain one PCBA board with LEDs, power source, metal base, transparent plastic lampshade, and a pair of side covers with metal contacts, but lack a disassembling system to change the board or any other component. By lacking this feature, once this type of lamps reach its end of service life or get damaged, the entire lamp has to be replaced eliminating the possibility of extending its service life by means of replacing the damaged components. Other types of lamps use organic LEDs to provide the color, desired quantity and quality of illumination. The great majority of them are circular in various lengths. These LEDs lamps are assembled inside a metal lighting fixtures which has a transparent cover. Inside the lighting fixtures there is a power source, as well as a control unit to control the power source and the PCBA board. Due to the fact that the tubular lamp is inside a metal lighting fixtures, this causes it to be less efficient and more expensive. The lamp operates at a higher service temperature than most LEDs lamps, which could affect the performance and service life. Some types of LEDs lamps in the market contain a PCBA board which includes a certain amount of LEDs. The PCBA board is supplied of energy coming from a power source. These lamps have a metal base, a transparent lampshade, two side covers with at least one metal contact. The lampshade can be removed from the metal base, but the side covers are attached to the base and lampshade permanently, which prevent to be completely disassembled. Due to this, this type of lamps lacks the capability of replacing any of its components in case of premature failure. Lastly, there are other types of LEDs lamps which contain a PCBA board with a PCBA board assembled in series-parallel arrangement. This type of lamps do not require a power source, due to the fact that each LED is protected by a resistor to prevent impairment of the LEDs due to an overload. As it has been mentioned, all the types of LED lamps make use of a PCBA board with LEDs. Also in most cases they use a metal base and a transparent plastic lampshade to be able to achieve the required luminance. Some other products use controllers, sensors or other type of electronic components to decrease or increase the current and achieve a smaller or larger luminous flux. Unfortunately, these lamps only have a PCBA board with LEDs, which forces the users to buy another lamp in case of damage to the PCBA board or any other component. Most of the lamps on the market do not use biodegradable materials to manufacture any of its components, and cannot be modified to increase or decrease its capacity and thus meet the individual needs of each customer.

The tubular lamp proposed by the invention has been conceived to solve these inconveniences at its best, which focuses its innovative features that consists of printed circuit board assembly “PCBA”, with one or more LEDs, which can be interchanged, eliminated, or replaced to provide different densities and luminous patterns, power source, side covers with one or more metal contacts, which are installed inside a metal base and a extruded semicircular lampshade built in different lengths and diameters. The external surface of the lampshade can be smooth, stripped or opaque to provide different luminous densities of the LEDs to the outside, providing the needed luminous flux to illuminate the desired area.

The tubular lamp can be totally be dismantled within minutes and any of its components can be replaced, changed or eliminated. This option will be very useful as it will not require to replace the entire lamp in the case any of components damages. It will help to decrease the environmental pollution since most of its components can be recycled and in case of its electronic components will not contain heavy metals such as lead, mercury or tin. On the other hand, some of its plastic components will have a percentage of organic fibers which will help to degrade them and thus reducing the impact on the environment. Since the plastic and metal components that comprise this product can be recycled, the pollution coming from the manufacture processes to fabricate them can be minimized.

There are certain requirements to provide the illumination, effectiveness and efficiency desired. Among other things, the following are some of the requirements to achieve the optimum design of a LED lamp. A high heat transfer rate is required to prevent that the LEDs stop working due to overheating. Generally, the absence of an adequate heat dissipation system increases the possibility of overheating, which causes a significant reduction in its performance, brightness, service life, and color. Therefore, the required heat transfer rate to avoid aforementioned problems is solved by means of using heat conducting materials, internal and external protrusions which can help to transfer the heat to the outside of the product, and the use of LEDs whose base is made of an thermal insulating material. The electronic circuits, electronic boards, power sources, and other electric/electronic components can affected if there is a high humidity level, dust or other type of contaminant inside the lamps. For this reason, the internal and external components of our invention have been designed in such a way that the amount of these type contaminants can eliminated as much as possible. The lampshade contains some lips in its periphery, which will rest on the flat surface of the base, making it difficult to contaminants and insects to access it. Also it will have some caps which will cover the space between the base and the lampshade once they are properly assembled. Said caps will help to seal the lamp and also to prevent the lamp from being dismantled while it is in use. On the other hand, the side covers will also help to seal the lamp due to the fact that the covers will be positioned on the side surface of the lampshade and base and will make contact with the internal surfaces of both components. This will help to seal the lamp and prevent contaminants such as insects from accessing to the inside. It has been proven that there are electricity conductive particles in the dust and air; therefore, it is very important to isolate this type of contaminants from the inside of the lamp and in this way safeguard the integrity of its electric/electronic components.

Another important aspect in the LEDs service life is the amount of current and voltage supplied to them. Thus, it is very important to use power sources that provide the right amount of current and voltage, that have a high power factor One of the reasons is to avoid sudden changes of current and thus ensure the LEDs service life. On the other hand, utilizing a power source with a high power factor ensures that the amount of energy provided to the source is used in generating light. A source with a high power factor ensures that consumed energy is used to power the LEDs lamp. Sources with a low power factor ≦50% use up to 50% of the amount of energy provided to light up the lamp. A 30 W lamp with a power source having a power factor of 50% will consume 60 W. There are sources with a power factor of 25% which means that the consumption of a 30 W lamp in reality will be of 120 W. Therefore, we expect that the power factor of the tubular lamp will be at least 85% which means that its total consumption will only increase up to 15% in comparison with other lamps which source has a smaller power factor. Lampshades, lenses, diffusers among other artifacts are used in the lightning industry to achieve the needed luminous differences to provide the amount of light at the required location. Therefore, the lampshade materials and features of our invention will play an important role in its performance throughout its service life. To obtain an optimum lampshade design we will use an ultra-transparent material, which allows the highest amount of light to be transmitted to the outside the lamp. The lampshade will have optical properties in its external surface, which will help to reduce the luminous flux whenever is necessary or will allow to reach the highest amount of light to be transmitted.

The PCBA boards, which contain LEDs, are covered by a smooth, opaque, diffused or striped semicircular transparent lampshade to obtain the distribution and direction of the desired luminous flux. Typically, these products use metallic bases with external and/or internal protrusions, which facilitate the transfer of the lamp's heat to the outside and so preventing the LEDs from overheating and fail prematurely. However, the products on the market lack the ability of changing the PCBA boards with LEDs if these are damaged. Our product is designed to be able to change, replace or eliminate the electronic PCBA boards, metal base, lampshade, power source or other component in case any of them come to fail and thus eliminate the risk of incapability to operate the product. That is, our invention has ability to continue to operate even if one or more PCBA boards are damaged. The intensity and density of the luminous flux will be affected by the absence of the disabled LEDs, but the lamp will not cease working entirely avoiding the acquisition and installation of a new lamp. This is a great benefit, because the user does not have to buy a lamp, even if the existing one fails for any reason. Due to the market potential of the invention, this aspect could mean millions of pesos in savings due to the acquisition of the damaged component only and not the whole lamp. Also, it must be mentioned that the lamp's luminous flux and density can be adjusted to the client's needs, by replacing the lampshade with another having different optical characteristics or installing PCBA boards with LEDs with different lighting capacities. This will be very useful since the lamp can be adjusted to match the required client's needs without having to use a product with more power required or worse yet, use a product which has not got sufficient capacity to illuminate the desired area and put at risk the safety of the inhabitants, residents or workers of a residential, commercial or industrial place.

Based on the development of the invention, we can present advantages of the LEDs tubular lamp as low electricity consumption, service life of 50,000 hours or more, low content of heavy metals (lead, mercury, tin, etc.), easy installation, interchangeable PCBA board with LEDs, minimum thermal emission, biodegradable components, rapid response to the electric current, use of an existing lighting fixture without the need of ballasts.

### BRIEF DESCRIPTION OF THE FIGURES

To complete the description we are making and with the aim of a better understanding of the invention characteristics, we join to this description and as an integral part of the same, the figures with illustrative character and not limited, we will present the following:

FIG. 1 Top view of isometric perspective of a PCBA board with LEDs grouped equidistantly in transversal form.

FIG. 2 Side view of a PCBA board with LEDs grouped in transversal form.

FIG. 3 Cross section of a PCBA board with LEDs showing holes through it.

FIG. 4 Rear view of a PCBA with LEDs grouped in transversal form.

FIG. 5 Front view of a PCBA with LEDs grouped in transversal form showing a SMT type connector.

FIG. 6 Top isometric perspective view of the lampshade.

FIG. 7 Front view of the lampshade.

FIG. 8 Detailed profile view of the lampshade.

FIG. 9 Detailed view of the “male” contact protrusions which are used to assemble the lampshade to the base of the tubular lamp.

FIG. 10 Top view of the lampshade.

FIG. 11 Side view of the lampshade.

FIG. 12 Longitudinal section of the lampshade.

FIG. 13 Perspective top isometric view of the tubular lamp.

FIG. 14 Front view of the tubular lamp showing the side cover.

FIG. 15 Side view of the tubular lamp.

FIG. 16 Top view of the tubular lamp.

FIG. 17 Bottom view of the tubular lamp.

FIG. 18 Left longitudinal section of the tubular lamp.

FIG. 19 Right longitudinal section of the tubular lamp.

FIG. 20 Top isometric perspective view of the base.

FIG. 21 Front view of the base showing the concave protrusions

FIG. 22 Detailed view of the base.

FIG. 23 Detailed view of the “female” contact cavity used to join the lampshade to the base of the tubular lamp.

FIG. 24 Side view of the base.

FIG. 25 Top view of the base.

FIG. 26 Bottom view of the concave protrusions of the base.

FIG. 27 Top isometric perspective view of the power source.

FIG. 28 Top isometric perspective view of the side cover.

FIG. 29 Side view of the side cover.

FIG. 30 Top view of the side cover.

FIG. 31 Rear isometric perspective view of the side cover.

FIG. 32 Top isometric perspective view of the upper cap.

FIG. 33 Top isometric perspective view of the multiple connector.

FIG. 34 Side view of the multiple connector.

FIG. 35 Top view of the multiple connector.

FIG. 36 Top view of the lamp with two variants of PCBA boards.

FIG. 37 Top view of the lamp with three variants PCBA boards.

FIG. 38 Top isometric perspective view with two variants of the PCBA boards separated by one divider plate.

FIG. 39 Top isometric perspective view of the divider plate.

FIG. 40 Top isometric perspective view of the tubular lamp with three variants of PCBA and divider plate.

FIG. 41 Top isometric perspective view of the conductive pin.

FIG. 42 Cross section of the tubular lamp.

FIG. 43 Detailed view of the tubular lamp.

FIG. 44 Detailed view of the tubular lamp.

FIG. 45 Cross section of the tubular lamp.

FIG. 46 Bottom isometric view of the tubular lamp.

FIG. 47 Rear isometric view of the side cover.

FIG. 48 Isometric view of the unifying plate with conductive pin and wire.

FIG. 49 Isometric view of the unifying plate with conductive pins.

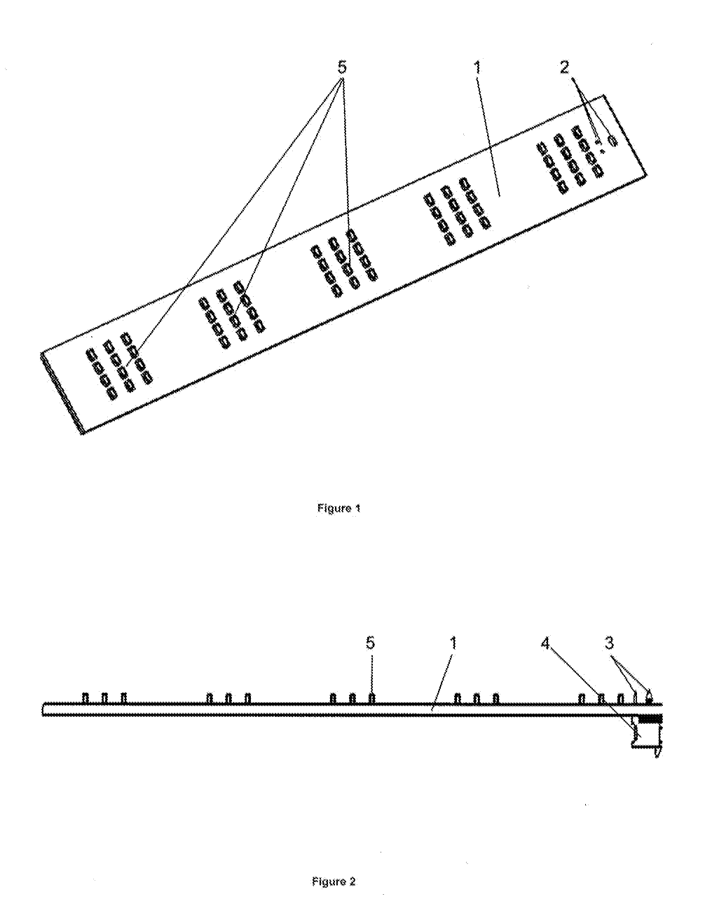

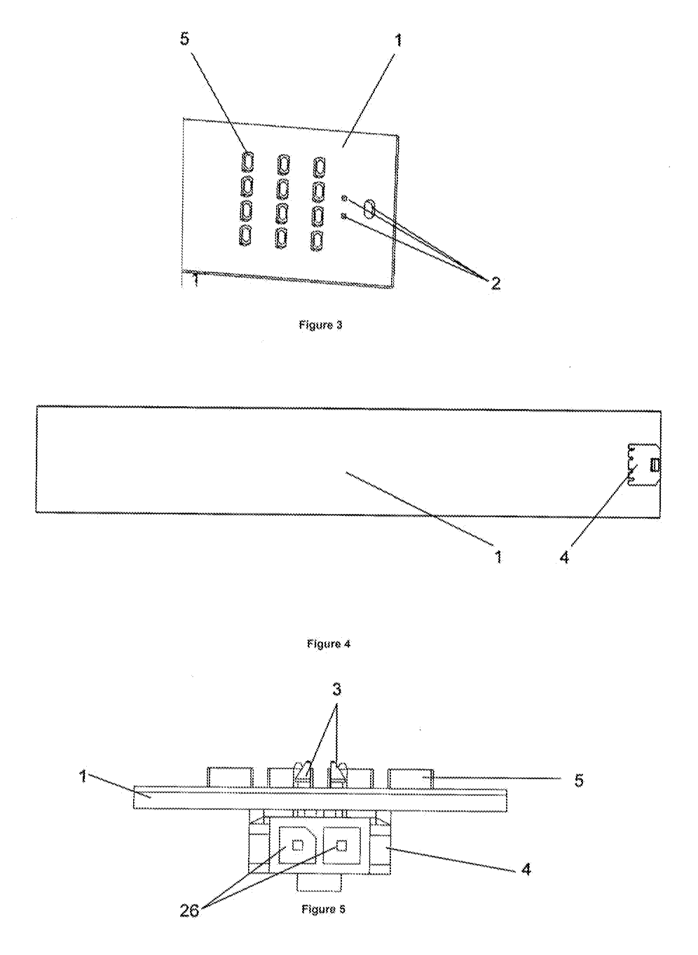

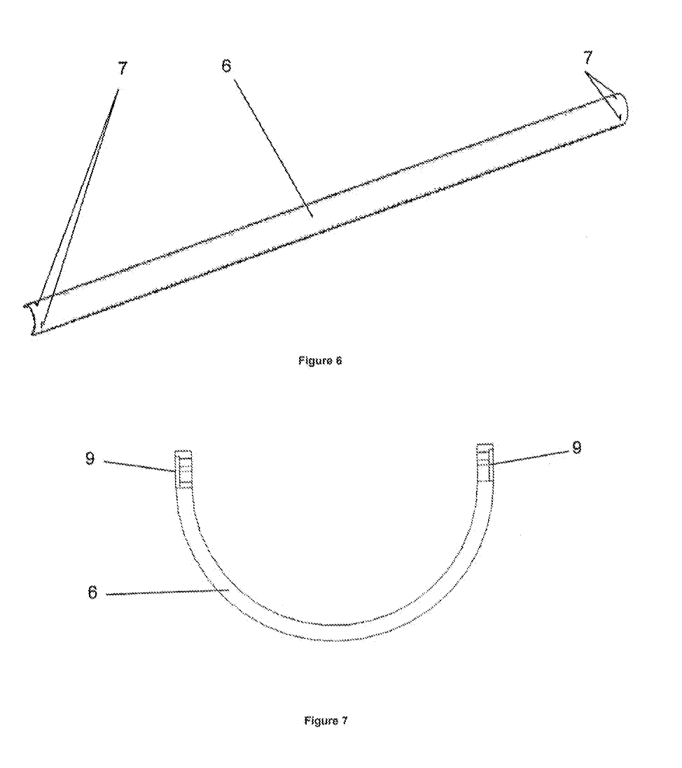

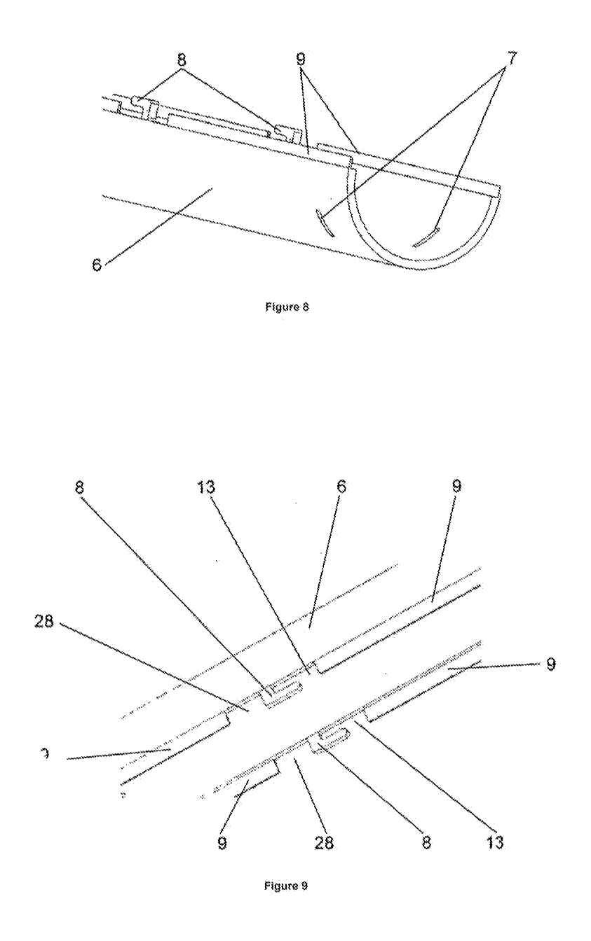

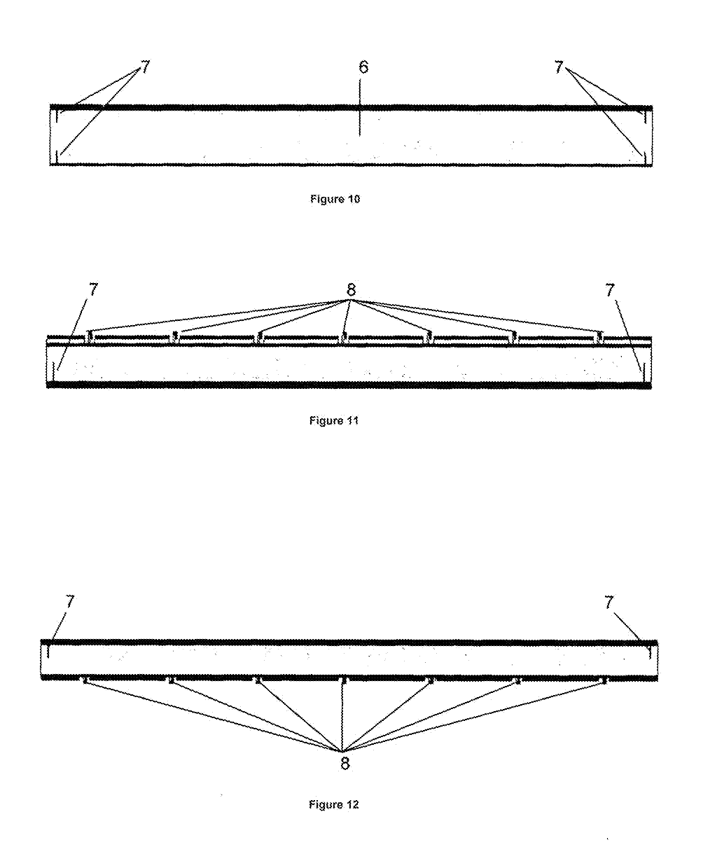

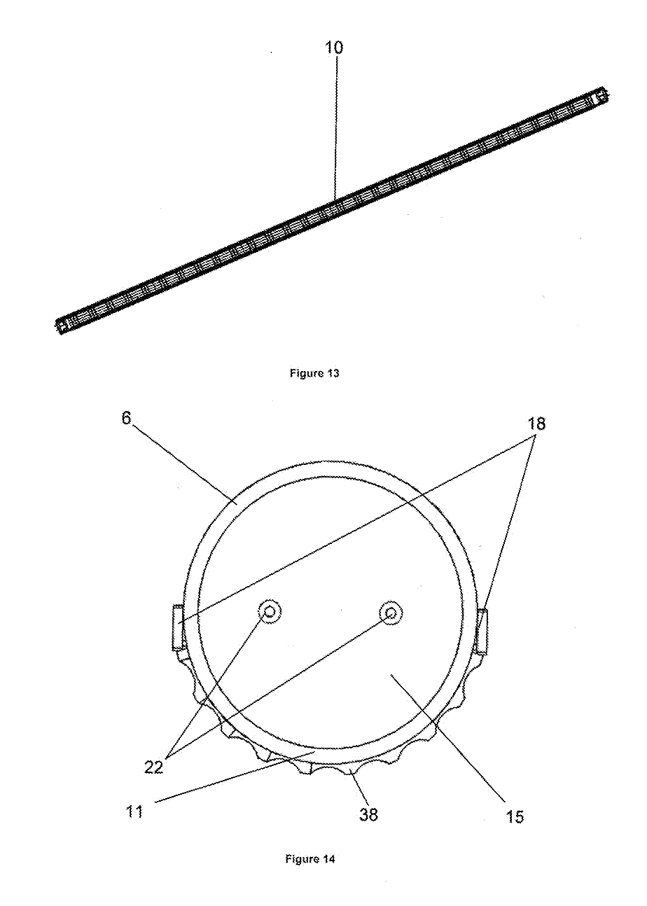

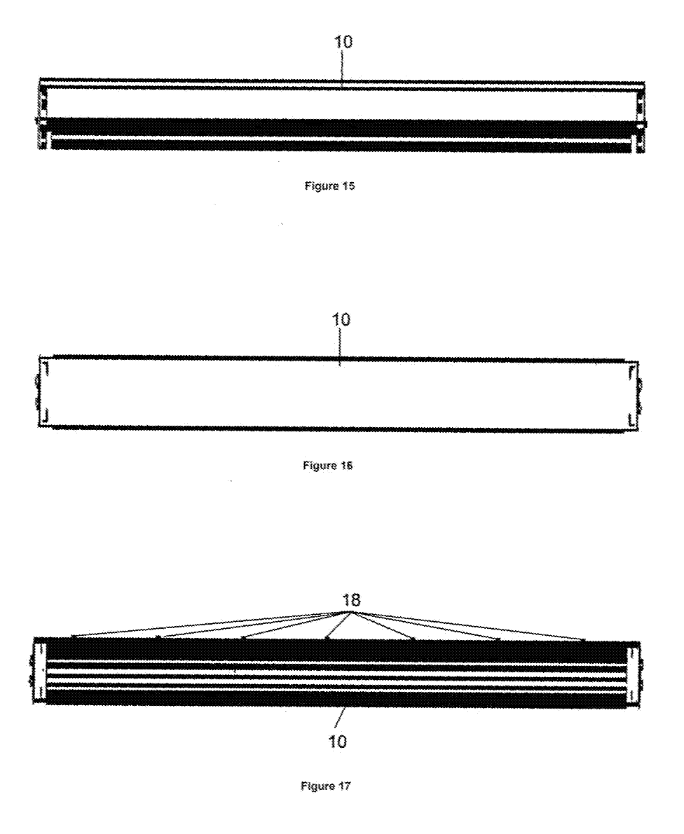

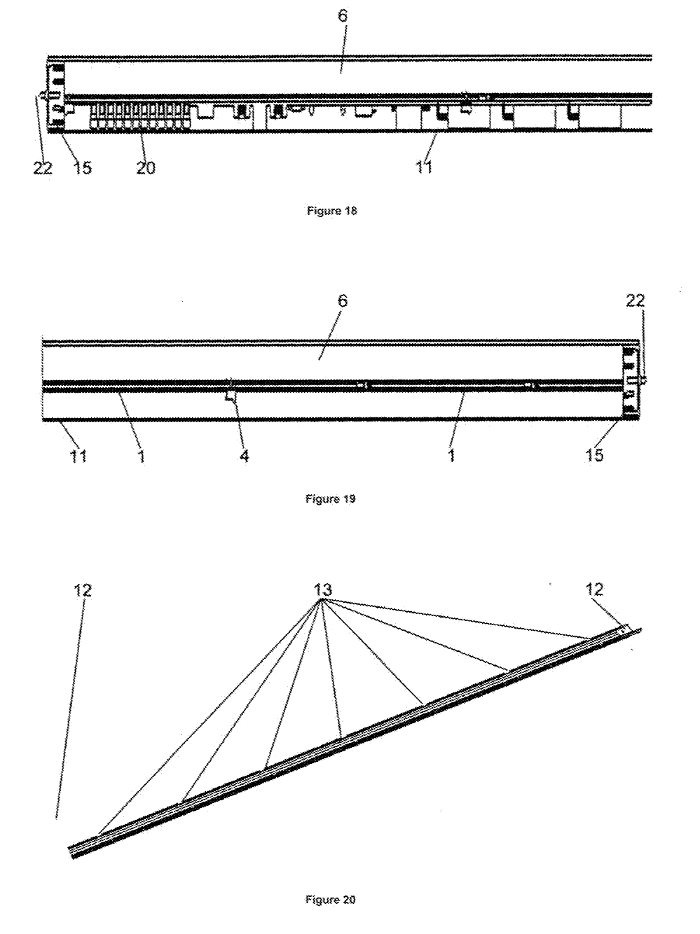

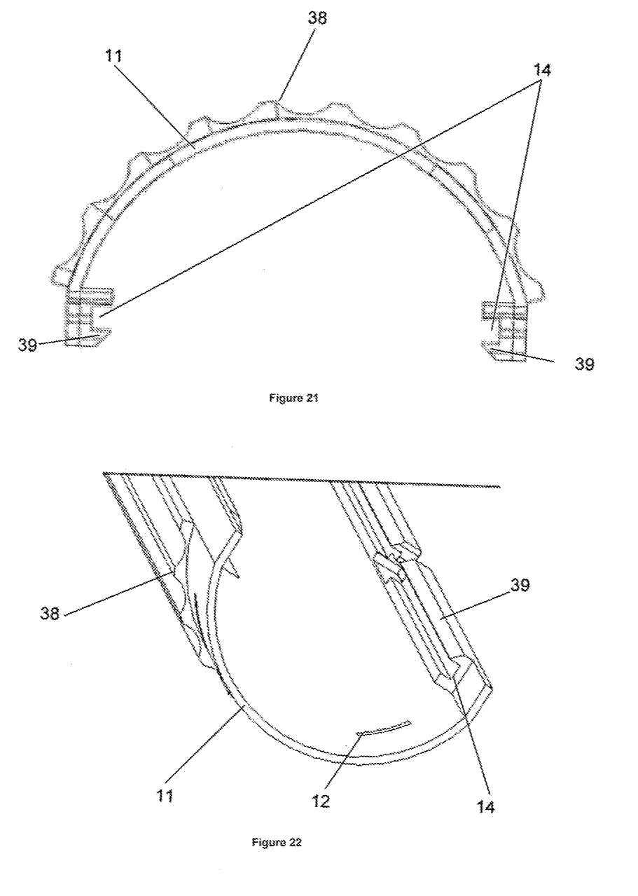

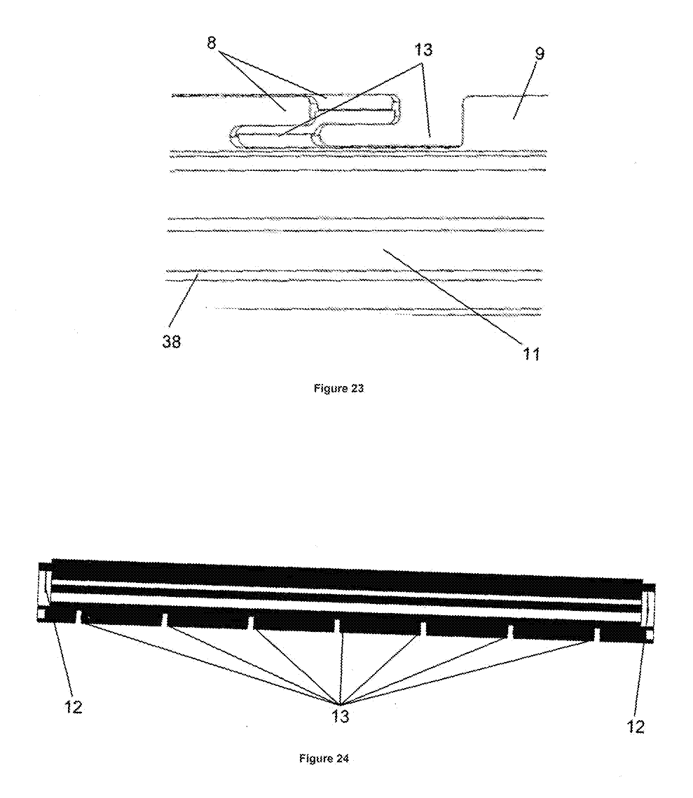

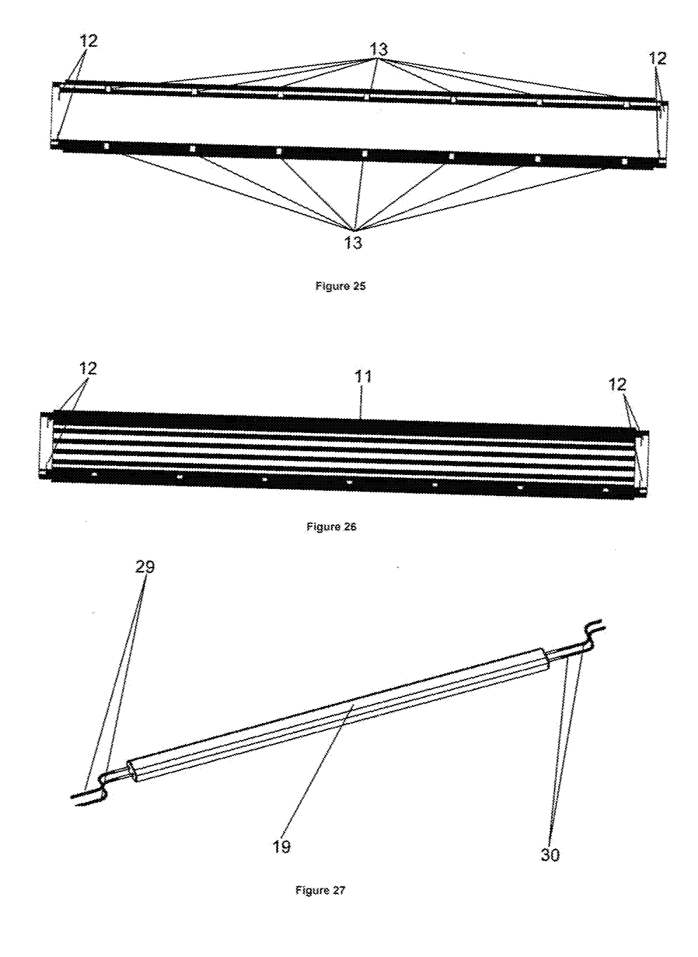

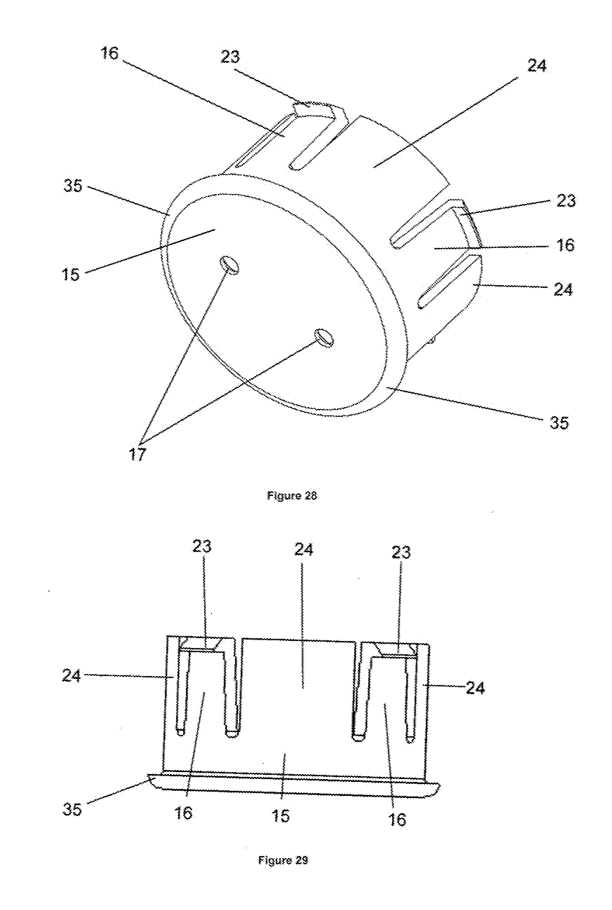

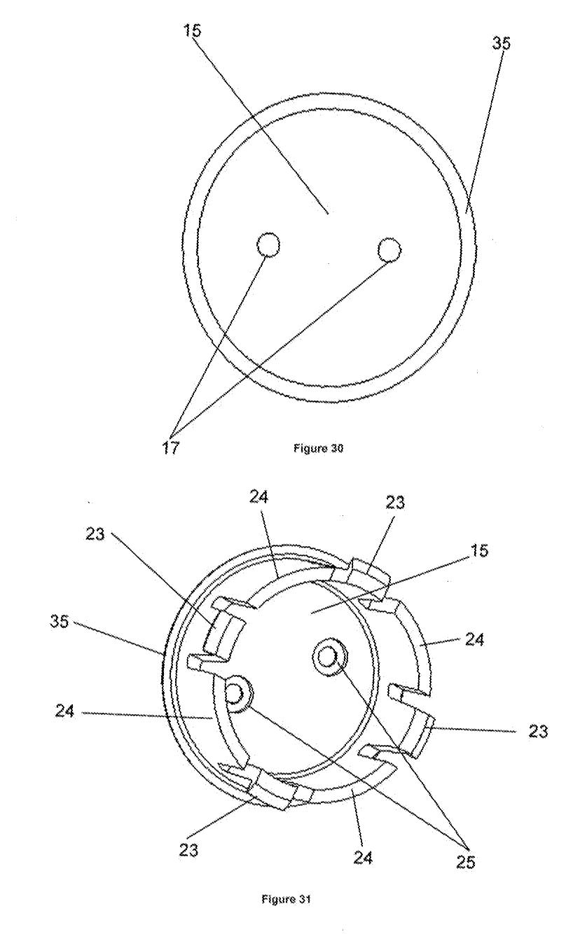

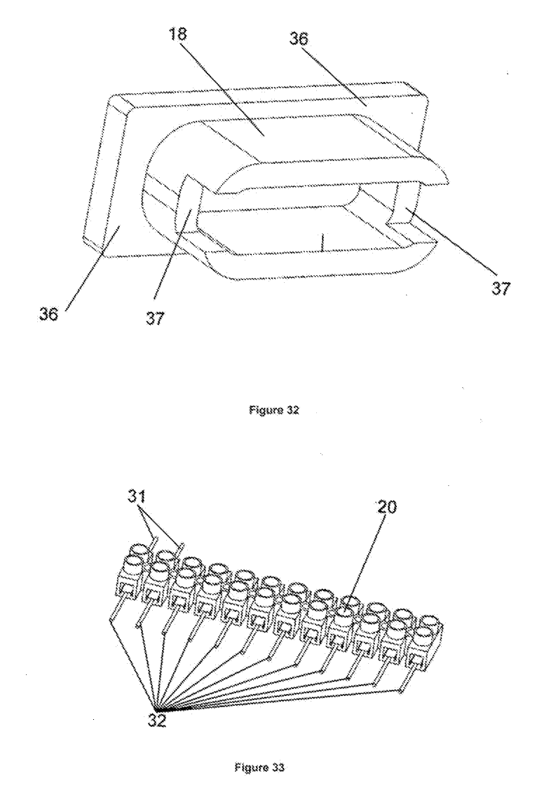

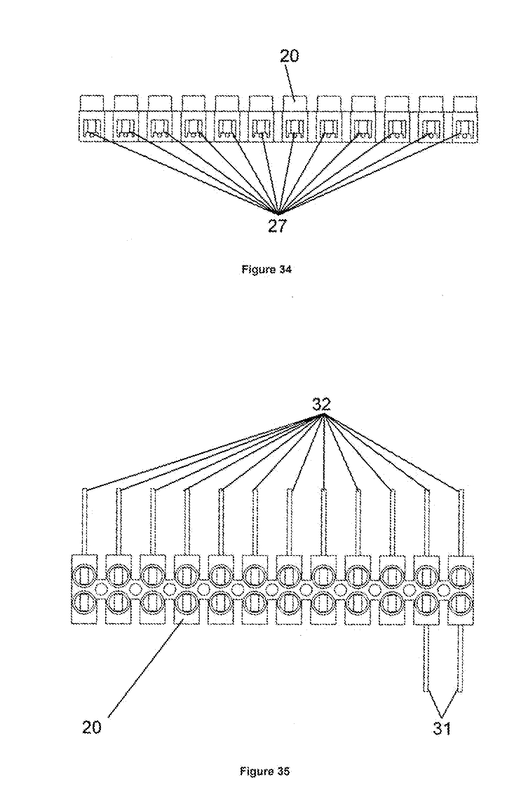

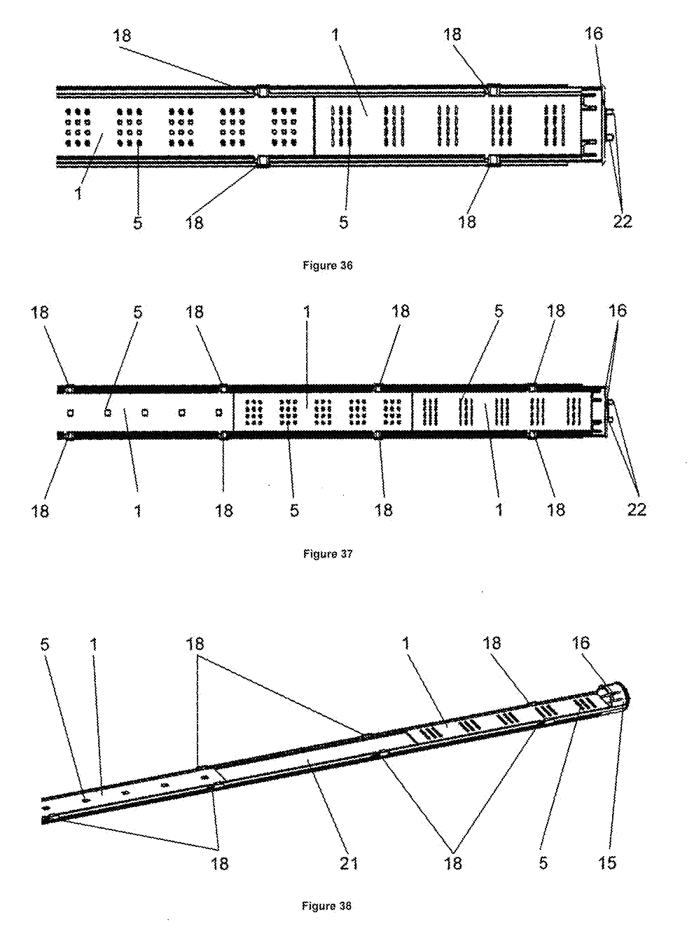

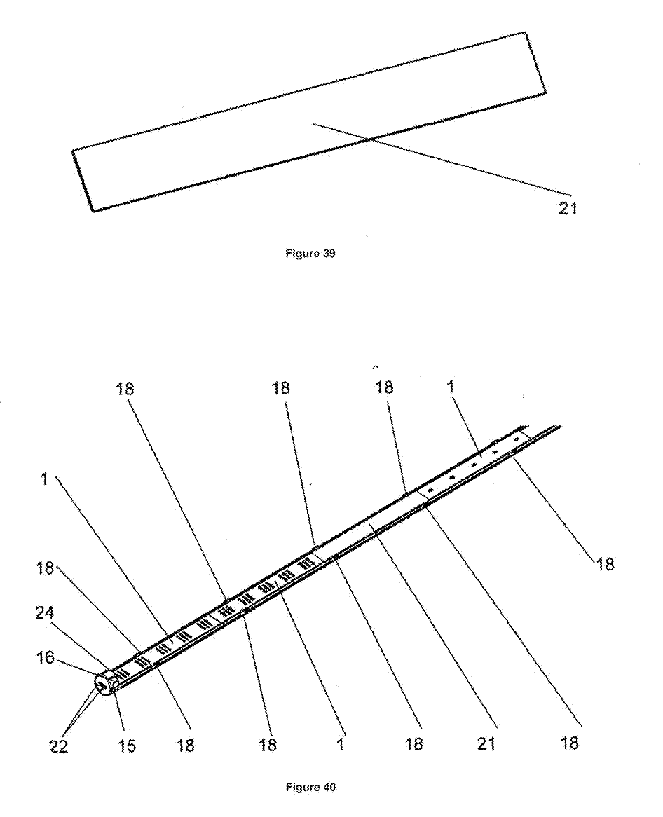

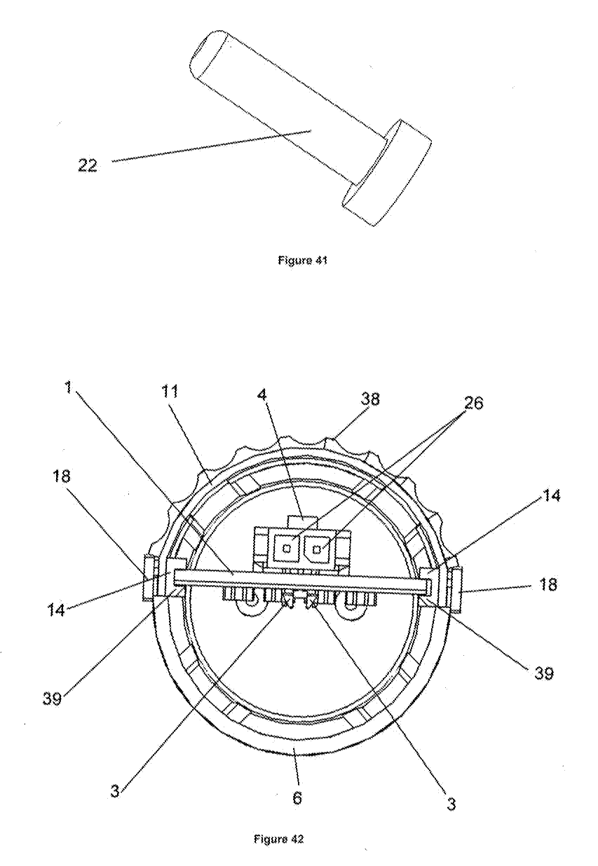

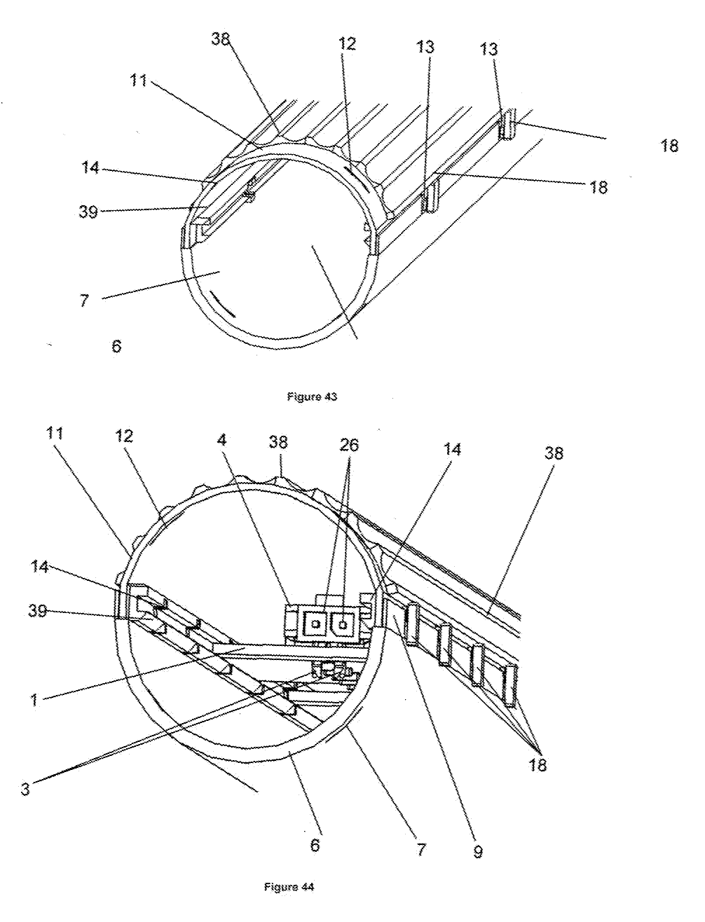

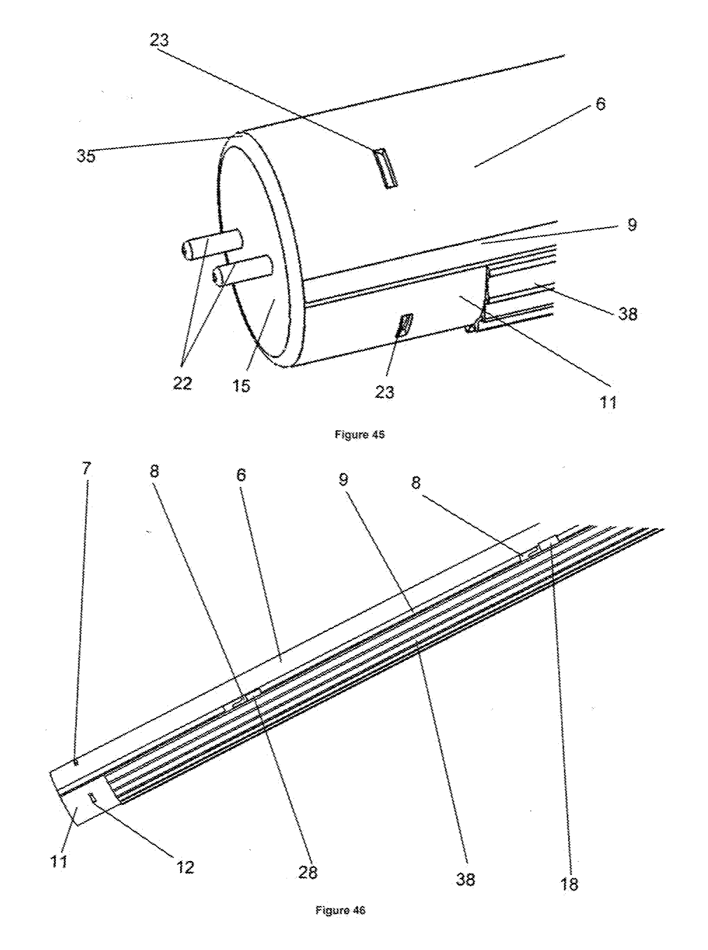

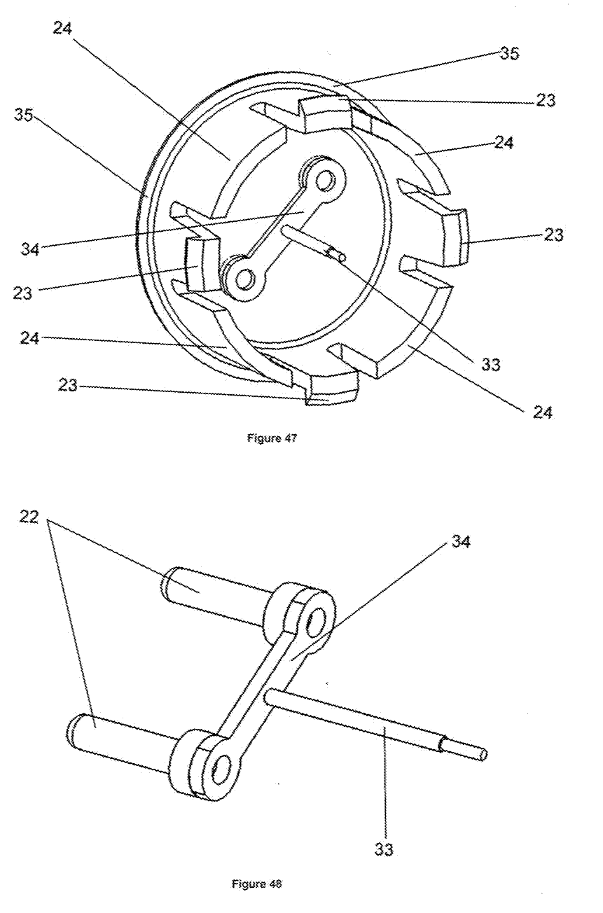

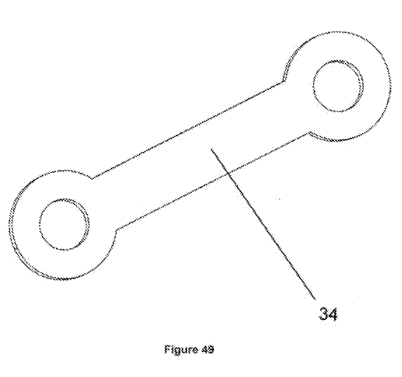

### DETAILED DESCRIPTION OF THE PREFERRED EMBODIMENTS

Based on aforementioned figures, the present invention relates to a tubular lamp that the elements that form allow to place at the least one PCBA board (1) of rectangular shape having at least one LED (5) in the PCBA board (1); the LEDs (5) are assembled to the PCBA board (1) in a superficial form, using specialized machinery (not shown in the Figures due to the fact that is not part of the invention) to make the manufacturing process repetitive, standardized and systematic; the LEDs (5) with thermal insulating ceramic base are grouped in matrix form; the LEDs (5) form rectangular groups with at least one column and a row of LED (5); the groups are formed of at least one LED (5) in the horizontal axis and of at least one LED (5) in the vertical axis; the LEDs (5) are separated in both axes (horizontal and vertical) unevenly; in the horizontal axis the distance from center to center of each LED (5) will be the same between them, but will be different to the distance from center to center of the LED (5) of the opposite axis (vertical axis); the PCBA board (1) or the total of PCBA boards (1) have three orifices (2) at one of its ends through which pass the perpendicular projections (3) of the SMT type connector (4), which allow assembling the SMT type connector (4) to the lower surface of the PCBA board (1) so as to be firmly soldered together; the soldering will help to reduce the risk of false contacts, short circuits and detachment of the SMT type connector (4) of the PCBA (1); the SMT type connector (4) will be used to supply the required current and voltage to the power source (19) and subsequently to the LEDs (5) assembled in the PCBA board (1); the PCBA boards (1) are manufactured out of Aluminum and/or other appropriate material and its upper surface will be covered with a chemical compound to avoid short circuits, false contacts or any other electrical problem, corrosion, contamination and/or oxidation; the number of PCBA boards (1) in each model of the tubular lamp (10) will vary, but could be from one PCBA board (1) up to a predetermined maximum depending on the type and size of the tubular lamp (10); the tubular lamp (10) can be entirely disassembled and most of its components can be replaced, switched and/or changed, except the power source, unless it has the same size and electrical capacity (current, voltage, frequency etc.), just as the LEDs (5) in individual form (due to the fact that these cannot be de-soldered or work independently); a PCBA board (1) can be exchanged by another with different types of LEDs (5), number of LEDs (5) or even number and group type of LEDs (5) or by a divider plate (21) of Aluminum and/or other appropriate material, with the same dimensions of the PCBA board (1); the upper surface of the divider plate (21) will be covered with a chemical compound, but this will not have orifices (2) nor SMT type connector (4), since its function is to fill the spaces caused by the absence of the PCBA boards (1) or more so avoid removing all of them; the divider plate (21) helps to decrease or increase the luminous output of the tubular lamp (10) since ii fills the space caused by the absence of a PCBA board (1) decreasing its rated capacity, in the contrary if the divider plate (21) is replaced by a PCBA board (1), the luminous output of the tubular lamp (10) increases; the metal base (11) is fabricated in one Aluminum piece or other appropriate metal since it will be subjected to a anodizing process to avoid corrosion, oxidation and contamination; the metal base (11) has a semi-oval shape due to the fact that its lower surface is semicircular, but has a straight surface (flat) on each side which provides an of “U” shape appearance; the external surface of the metal base (11) has some concave protrusions (38) which stretch on its periphery to provide a greater stability, rigidity, and help to obtain the required heat dissipation to avoid overheating of the LEDs (5) and cease working prematurely; due to the use of its external protrusions, the heat transfer rate will be greater than if the base did not have the protrusions, since the surface of the metal base (11) in contact with the air flow will be larger which will help to remove the excess heat from the tubular lamp (10); inside the metal base (11) there are some parallel protrusions in channel form which serve as rails (14); the protrusions are separated by a predetermined distance on the vertical axis, a protrusion will be called upper because it located at the greatest distance from the central point of the internal concavity of metal base (11), the upper protrusion will have a 45 degree cut, which will help to direct the luminous flux from the LEDs (5) to the outside of the tubular lamp (10); the 45 degrees angle will minimize the light losses and maximize the efficiency of the tubular lamp (10); once the PCBA board (1) and/or in its case the divider plate (21) or all the PCBA boards (1) and/or divider plates (21) are slid over the rails (14) of the metal base (11) on the final position, the rail (14) will restrict the vertical and lateral movement of the PCBA boards (1) and divider plates (21); the side cover (15) will be assembled to restrict the horizontal movement of PCBA board (1) or all the PCBA boards (1) and/or divider plates (21); the side covers (15) jointly with the rails (14) of the metal base (11) will completely restrict the movements of the PCBA board (1), all the PCBA boards (1) and/or divider plates (21); internally, the tubular lamp (10) is comprised of at least one PCBA board (1) with LEDs (5), SMT type connector (4), power source (19), multiple connector (20), conductive pins (22), side covers (15) and wires (29),(30),(31),(32) and (33); once the PCBA board (1) or all the PCBA boards (1) are slid into their final position, to the contact cavities (26) of the SMT type connector (4) of each PCBA board (1), two output wires (32) will be connected from the multiple connector (20), the connection to the multiple connector (20) will be through its cavities (27); the wires (31) from the cavities (27) of the multiple connector (20) will be connected together to the output wires (30) from the power source (19), to supply current and voltage to the multiple connector (20); the power source (19) will have two input wires (29), which will be connected to the output wires (33) of the unifying plate (34); the wires (33) are permanently assembled to the unifying plate (34) using a fastening device; the conductive pins (22) are insert by pressure in the blind orifices (25) of the side cover (15) and go through the thru orifices (17) resting inside permanently; the conductive pins (22) are connected to the unifying plate (34) using a fastening device which allow the conductive pins (22) and the unifying plate (34) stay firmly and permanently assembled; the conductive pins (22) will be the interface between the exterior and the tubular lamp (10); through the conductive pins (22) the needed current and voltage will flow to keep the tubular lamp (10) lit the needed time; externally the tubular lamp (10) will have a side cap (18), lampshade (6), metal base (11), side covers (15) and conductive pins (22).

To completely assemble the tubular lamp (10) it is necessary to insert the PCBA board (1) or all the PCBA boards (1) and/or divider plates (21) in the rails (14) of the metal base (11); similarly the power source (19), multiple connector (20) and wires (29),(30),(31),(32) and (33) will be inserted so all the necessary electrical connections are made; The rails (14) of the metal base (11) are comprised by two parallel protrusions (39) which stretch intermittently along the metal base (11); the parallel protrusions (39) are rectangular in shape dimensionally identical between them, except that the upper protrusion has a 45 degrees cut to help direct the luminous flux of the tubular lamp (10) to the exterior and in that way increase its performance; the concave protrusions on the external surface of the metal base (11) will help to obtain a greater stability and rigidity and at the same time to increase the heat exchange of the tubular lamp (10) with the environment; the LEDs (5) would have to be kept within a working temperature range between (−30 to 85° C.) to avoid a premature failure; for this reason it is imperative to dissipate heat to the outside of the tubular lamp (10) in a constant fashion and avoid temperature build up inside the tubular lamp (10), especially in the PCBA boards (1) with LEDs (5), and power source (19); externally, a lampshade (6) in “U” shape will be placed over the metal base (11) to form a circular structure; the lampshade (6) has two side orifices (7) contact male protrusions (8), and anti-dust side walls (9); the metal base (11) has lateral orifices (12) female type contact cavities (13) which have a “L” shape; the side covers (15) have flexible snaps (16), which have a contact lip (23); the flexible snaps (16) are capable to fasten uniformly and permanently to the side orifices (7) of the lampshade (6) and lateral orifices (12) of the metal base (11) through a contact lip (23); the fastening strength of the contact lip (23) of the flexible snaps (16) is possible due to the deformation resistance existing in the flexible snaps (16) during the time the side covers (15) are inserted between the lampshade (6) and the metal base (11); the metal base (11) and lampshade (6) will be attached to each other through the contact male protrusions (8) and the female type contact cavities (13); the lateral and horizontal displacement of the lampshade (6) and the metal base (11) like the access to foreigner materials to the metal base (11) will be restricted by the anti-dust side walls (9) and the side cap (18); once the lampshade (6) is placed over the metal base (11) and making sure that the contact male protrusions (8), the female type contact cavities (13) and the anti-dust side walls (9) are positioned correctly, the lampshade (6) will be slid over the metal base (11) at a premeditated distance with respect the metal base (11) to reach its final position and thus ensure a perfect assembly between the two components; Subsequently the side covers (15) will be installed, which will be inserted at each end of the tubular lamp (10) and will keep contact with the lampshade (6) and the metal base (11) through the external contact surface (24), peripheral lip (35), flexible snaps (16) and the contact lip (23); the flexible snaps (16) will attach to the side orifices (7) of the lampshade (6) and to the lateral orifices (12) of the metal base (11) through each contact lip (23); the peripheral lip (35) of the side covers (15) will help to restrict the total insertion of the side covers (15) towards the inside of the tubular lamp (10) and avoid that any foreign object makes its way to the interior of the tubular lamp (10); each side cap (18) will be placed on each opening (28) which are caused by the horizontal displacement of the lampshade (6) in relation to the metal base (11); each side cap (18) aids to avoid that the tubular lamp (10) may come apart during its use since the protecting protrusion (37) will be inserted through the opening (28) and will be positioned to the sides of each PCBA board (1) and/or divider plate (21) preventing both from moving laterally or vertically; the protecting protrusion (37) will prevent the lampshade (6) with respect to the metal base (11) from being disassembled while the tubular lamp (10) is in use; the upper surface (36) of the side cap (18) will help to seal the tubular lamp (10) when it is assembled over the anti-dust side walls (9) of the lampshade (6) and will prevent that each side cap (18) be completely inserted inside the tubular lamp (10).

The tubular lamp (10) can be disassembled and most of its components can be replaced, switched and/or changed except the power source, unless the new has the same size and characteristics (current, voltage frequency etc.) and the LEDs (5) individually (due to the fact that they can't be de-soldered); the PCBA board (1) could be changed by another with different kind of LEDs (5), number of the LEDs (5) or even number and grouping types of LEDs (5) placed on the PCBA board (1) and/or by a divider plate (21) which will help to increase or decrease the luminous capacity of the tubular lamp (10); exchanging or changing the lampshade (6) of the tubular lamp (10) by another with a different external surface (opaque, diffuse or striped) will help to achieve a different luminous flux and luminesce; like this, the luminesce could be increased or decreased; since the lampshade (6) is made out of plastic, pigments could be added to the resin (polymer) during its manufacturing process to obtain different luminescence and luminous flux; this process would have to be performed during the manufacturing process of the lampshade (6) since the pigments must be mixed with the polymers (plastic resins) to obtain the desired color and tone.

Some components of the tubular lamp (10) will be made combining polymers and organic fibers so that they can be degraded in the least amount of time once they reach the end of life; the components that will use these compounds are the side covers (15), side caps (18), as well as the power source cover (19); also recycled metals will be used 10 manufacture the metal base (11), PCBA board (1), unifying plate (34), conductive pins (22) and divider plate (21); the manufacturing process of the PCBA board (1) with LEDs (5), SMT type connector (4) and power source (19) the use of solder material with minimum content of heavy metals (lead, tin, etc.) will be required to prevent that these components of the tubular lamp (10) adversely impact the environment during use and when the lamp reaches its end of life.

What is claimed is:

Having fully described my invention, what I consider it a novelly and for this reason I claim of my property the content of the following claims;:

1. Tubular lamp, which have a PCBA board with LEDs, a power source inside the lamp and side covers, which can be removed to replace the PCBA board, characterized because it can house at least one rectangular PCBA board with at least one LED; the LEDs which are assembled to each PCBA board in a superficial manner, (employing specialized machinery to make the process repetitive, standardized and systematic not shown because is not part of this invention); having a matrix form with a specific number of rows and columns of LEDs; the distance from center to center between the LEDs in an axis will be the same, however this will be different from the distance from center to center of the LEDs on the opposite axis; the groups of LEDs arranged in group form are separated from the next group by a distance of equal magnitude at the distance between the adjacent groups; the base of the LEDs works as a thermal insulator since the material is ceramic; the number, type, spacing, temperature color and orientation of the LEDs will increase the performance of the tubular lamp, providing a specific luminescence and luminous density; the PCBA boards have at least three orifices which will allow the assembly of a SMT type connector to the lower surface of the PCBA board to be fixedly and permanently soldered to the PCBA board to prevent the SMT type connector from coming loose, or creating false contacts; the perpendicular protrusions of the SMT type connector will pass through the PCBA board orifices allowing the SMT type connector to supply the required energy to the LEDs on the PCBA board; the PCBA boards will be manufactured in Aluminum and/or other appropriate material and the upper surface will be covered with a chemical compound which will help to prevent short circuits or other electrical problems; the number of PCBA boards in each model of the tubular lamp will vary, the number PCBA boards could vary from one up to a permissible maximum set by the type and size of the tubular lamp; which will help to provide the required amount of light and thus preventing unnecessary energy expenditures; the spaces produced by the absence of PCBA boards will be covered by divider plates made of Aluminum and/or other suitable material; the upper surface will be covered with a chemical compound and will have dimensioned identically like the PCBA boards; the divider plates will not have any orifices nor connectors, since their only function is to cover the spaces produced by the absence of any of the PCBA boards; the metal base is extruded in one anodized piece and covered with colored compound to prevent the corrosion, it is shaped in a semi-oval form since its lower surface is semicircular, but has a flat surface on each side which provides a “U” appearance; inside the metal base there are some protrusions in channel shape produced by two parallel protuberances which are part of the flat surfaces at each side of the metal base and protuberances are the rails found in the metal base and project to the inside of the metal base almost from end to end, both the PCBA boards as well as divider plates are slid over the rail to be placed in its final position, allowing to restrict the lateral and vertical movements of both components; the metal base on its external surface has several concave protrusions which stretch on its external periphery lengthways of the metal base to provide greater stability, rigidity and the required amount of heat transfer to prevent overheating the LEDs to avoid a premature failure; the heat transfer rate will be achieved through conduction and free convection, which are the heat transfer modes that will be employed to transfer heat from the tubular lamp to the environment; due to these heat transfer methods, the air will flow over the lamp and will it cool down by removing the excess of heat generated by the LEDs, power source and electrical current which will flow through the conductive pins; at each end of the metal base over the semicircular surface there are two rectangular orifices which are separated at 90 degrees from each other, these will help to fasten the side covers through the use of contact notches; through the flat surfaces of the metal base the female type contact cavities are found, which have a profile similar to a “L”; the cavities go through the metal base from side to side, to reduce placement and location variations in each side of the metal base; a power source and a multiple connector are found inside the metal base, which are interconnected by wires and fastening devices; the power source has a pair of output wires, which will be connected to the contact cavities of the multiple connector through fastening devices; the output wires of the multiple connector will be connected to the SMT type connectors of the PCBA boards through fastening devices, in an independent fashion to supply the necessary current and voltage to each PCBA board; the conductive pins will be placed inside the blind orifices and will go through the thru holes of the side cover to restrict the movement and be exposed to the external electricity supply; once in its final position, the conductive pins through the output wires will be connected to input wires of the power source; once the PCBA boards, multiple connector, power source and side covers with conductive pins are connected among them, and in the final position, the lampshade will be placed over the metal base aligning the contact male protrusions and female type contact cavities, in addition to aligning over the external lateral surfaces of the metal base the anti-dust side walls of the lampshade to begin sliding horizontally the lampshade a predetermined distance with respect to the metal base; once the lampshade has been slipped to the final position with respect to the metal base an assembly amongst both components will be created; the lampshade will be manufactured with a transparent material which will allow a greater luminous flux coming from the LEDs exit the lamp and light the desired area; the lampshade has a semi-oval profile shaped like a “U” as is the case of the metal base; the semicircular portion of the lampshade is coupled to the anti-dust side walls which stretch on each side of the lampshade from one end to the next in an intermittent fashion; the walls are parallel to the contact male protrusions; to allow the existence of the protrusions the anti-dust side walls are interrupted in a systematic fashion along the lampshade; the anti-dust side walls allow to restrict lateral movements of the lampshade once is placed in its final position; also restrict the entry of any foreign material to the interior of the lamp and allow to position the contact male protrusions over the female type contact cavities to create an assembly amongst both components; finally, the orifices generated by the displacement of the lampshade over the metal base will be sealed by using side caps mounted under pressure; the side caps permit to cover the orifice caused by the displacement of the lampshade and prevent the disassembly of the tubular lamp when is mounted in the lighting fixture and is fully energized.

2. The tubular lamp as it was stated previously in claim 1 characterized, because it can use variations of the PCBA board with different types of LEDs, number of LEDs or even number and type of groups of LEDs which will help to increase or reduce the optical characteristics of the tubular lamp.

3. The tubular lamp as it was stated previous claims characterized, because the PCBA boards are manufactured in Aluminum and/or any other appropriate material so it can work as a dissipator.

4. The tubular lamp as it was stated previous claims characterized, because the internal surface of the lampshade will be smooth and the external one could be smooth, striped or rough to allow the quantity, quality; density and luminous flux to be adequate.

5. The tubular lamp as it was stated previous claims characterized, because its lampshade has contact male protrusion, which allows it to assemble to metal base.

6. The tubular lamp as it was stated previous claims characterized, because the pigments used in the manufacture of the lampshade to decrease the light transmission capacity of the LEDs.

7. The tubular lamp as it was stated previous claims characterized, because each upper protrusion that comprise the rails has a 45 degree cut to orient the luminous flux coming from the LEDs to the exterior and minimize the energy losses,

8. The tubular lamp as it was stated previous claims characterized, because the rails allow the displacement of the PCBA boards and the divider plates to restrict the components from moving laterally and vertically; also, it contains two lateral walls, which support the lampshade's anti-dust side walls and female type contact cavities to assemble the lampshade over the metal base.

9. The tubular lamp as it was stated previous claims characterized, because the side cover and side cap are made of a mixture of polymers and organic fibers to reduce the pollution and render them biodegradable.

10. The tubular lamp as it was stated previous claims characterized, because the side cover has flexible snaps, which have a contact lip to be firmly attach to the lampshade and the metal base.

11. The tubular lamp as it was stated previous claims characterized, because the side cover has a peripheral lip which allows the cover not to be inserted completely in the tubular lamp and at the same time to seal its extremes.

12. The tubular lamp as it was stated previous claims characterized, because the side cover has a pair of blind orifices which prevent the conductive pins from moving or displacing laterally and grab them firmly once the pins are inserted under pressure.

13. The tubular lamp as it was stated previous claims characterized, because the side cover has a pair of thru holes which allow the conductive pins to go out the other end of the side cover and be exposed to the electric current coming from the electricity source.

14. The tubular lamp as it was stated previous claims characterized, because it can be put together and dismantle entirely to replace, exchange and/or change most of its components, except the power source, unless it has the same size and electrical characteristics (current, voltage, frequency, etc.), in the same manner the LEDs in individual form (due to the fact that these cannot be de-soldered).

15. The tubular lamp as it was stated previous claims characterized, because each side cap has an upper surface which helps to prevent that any foreign material get inside of the tubular lamp.

16. The tubular lamp as it was stated previous claims characterized, because each side cap has an upper surface that helps to prevent the complete insertion to the interior of the tubular lamp.

17. The tubular lamp as it was stated previous claims characterized, because each side cap has a protecting protrusion which helps to prevent the PCBA boards from displacing laterally, horizontally and vertically, also helps to center the PCBA boards with respect to the tubular lamp's central axis.

18. The tubular lamp as it was stated previous claims characterized, because each side cap helps to avoid the metal base and lampshade to be disassemble during use.

19. The tubular lamp as it was stated previous claims characterized, because the unifying plate is made of copper and/or other appropriate material that acts as an electricity conductor.

20. The tubular lamp as it was stated previous claims characterized; because the unifying plate is permanently assembled to the conductive pins through the use of a fastening device (solder paste, rivets or screws).

21. The tubular lamp as it was stated previous claims characterized, because the unifying plate has an orifice at each end to directly connect to each conductive pin.

22. The tubular lamp as it was stated previous claims characterized, because the soldering material used to permanently assemble the LEDs and SMT type connector to the PCBA board will not contain lead, tin, or other heavy metal.
